(19) United States
(12) Patent Application Publication
(10) Pub. No.: US 2025/0034364 A1
(43) Pub. Date: Jan. 30, 2025

(54) FUNCTIONALIZED SILICA FOR ODOR REDUCTION OF POLYOLEFIN AND ENGINEERING THERMOPLASTIC POLYMERS

(71) Applicant: SABIC GLOBAL TECHNOLOGIES B.V., BERGEN OP ZOOM (NL)

(72) Inventors: Jonathon SCHOLIN, Bangalore (IN); Tianhua DING, Bangalore (IN); Kevin EILERS, Bangalore (IN); Stephan MOYSES, Bangalore (IN); Jun WANG, Bangalore (IN); Liheng WU, Bangalore (IN)

(73) Assignee: SABIC GLOBAL TECHNOLOGIES B.V., BERGEN OP ZOOM (NL)

(21) Appl. No.: 18/832,862

(22) PCT Filed: Jan. 19, 2023
(86) PCT No.: PCT/EP2023/051298

§ 371 Date: Jul. 24, 2024

(30) Foreign Application Priority Data
Jan. 21, 2022 (EP) 22152591.8

(51) Int. Cl. C08K 9/06; B01J 20/22; B01J 20/28; B01J 20/32

(52) U.S. Cl. CPC C08K 9/06; B01J 20/22; B01J 20/28061; B01J 20/28073; B01J 20/28076; B01J 20/28083; B01J 20/3204; B01J 20/3219; B01J 20/3257; C08K 2201/006

(57) ABSTRACT

Thermoplastic compositions having reduced odor are described. A thermoplastic composition can include a thermoplastic polymer and a dual active functionalized silica (e.g., an amine-functionalized silica having a specific surface area of less than 450 m2/g and a nitrogen content of at least 1.2 wt. %). Such a thermoplastic composition has decreased odor-active volatile organic compounds (VOCs) emissions when compared with the same thermoplastic composition that does not include the dual active functionalized silica.

### CROSS-REFERENCE TO RELATED PATENT APPLICATION

This application claims the benefit of European Patent Application No. 22152591.8 filed Jan. 21, 2022. The entire contents of the above-referenced disclosures are specifically incorporated herein by reference.

### BACKGROUND OF THE INVENTION

### A. Field of the Invention

The invention generally concerns a thermoplastic composition comprising a thermoplastic polymer and a dual-action functionalized silica particles (e.g., an amine-functionalized silica particle). Such a thermoplastic composition has reduced odor-active volatile organic compounds (VOCs) as compared to the same thermoplastic composition that does not contain the dual-action functionalized silica.

### B. Description of Related Art

Polymer odor is a long standing issue that has persisted for several decades, but recently has been gaining awareness as society becomes increasingly dependent on plastic materials. Current global trends aiming to curb chemical emission released into the environment have led to a similar concern of plastic emissions in enclosed spaces (e.g., home, office, automobiles). Automobile consumers have growing concern with chemical emissions from plastics affecting the indoor air quality of vehicles.

The reduction of odor emissions from polymers is complex due to many factors (e.g., raw materials, polymerization chemistry, thermal processing, and the like.). Current practice and technologies available to reduce polymer odor include cleaner resins, post-reaction conditioning, and additives. Cleaner resins can involve the use of high purity raw materials and an efficient production process. In addition, the entire manufacturing process from polymerization through extrusion of the resin needs to be clean and run efficiently to prevent the formation of unintentional malodors. This approach suffers from high cost and potentially limits material production, ultimately creating a bigger challenge for manufacturers to keep up with customer demand. Another attempt to reduce odors can involve post-reaction conditioning, which can reduce volatile compounds from the polymer resin. This solution suffers from indiscriminate removal of volatile and sometimes necessary additives (e.g., thermal stabilizers). Thus, creating formulation issues for the final product. Another option to reduce odors can be to provide different types of liquid or solid additives that can be compounded with polymer resins to reduce odor. This approach presents formulation challenges to balance additive loading and product performance to prevent changes to the inherit polymer properties (e.g., physical, mechanical, and the like.). One class of additives are inorganic or organic adsorbent powders (e.g., calcium carbonate, aluminosilicates, cyclic oligosaccharides, and the like) which are compounded with resin at loading levels <10 wt. % to trap small molecules co-existing in the molten resin. Adsorbent materials can be partially selective towards molecules based on their polarity, however, the adsorbent materials are indiscriminative toward interacting with any lower molecular weight species which is ultimately problematic for other additives (e.g., thermal stabilizers, fillers, and the like.). For example, Japanese Patent Publication No. 4831519 to Takayuki et al. entitled “Amine Carrying Porous Silica, Resin Composition Containing the Porous Silica and Multilayered Structure Containing Resin Composition” describes a multilayer resin structure that has an odor barrier layer and an oxygen-adsorbing layer to scavenge odors in plastic materials used in food and beverage applications. The odor barrier includes an amine-supported porous silica for capturing odorous substances generated in the oxidation layer. This application suffers in that it requires multiple barrier layers and is dependent on generating odors through the oxygenate layer. Another type of additive is odor maskers which are considered to be high-intensity “good” smelling compounds. Odor maskers such as terpenes or synthetic oils are used readily across different product markets (e.g., personal care) to boost consumer appeal to a product. Additive approaches have limitations (e.g., thermal stability, odor removal efficacy) and have been found to not meet performance expectations.

While many methods are known to reduce odors in plastic materials to increase their commercial appeal, there is a still a need for more efficient, cost effective methods to produce odor-free thermoplastic compositions.

### SUMMARY OF THE INVENTION

A discovery has been made that provides a solution to at least one or some of the problems associated with odiferous thermoplastic compositions used to produce articles of manufacture. The discovery is premised on a dual-action additive dispersed in the thermoplastic composition. The dual-action additive can be effective at reducing polymer odor at loadings of less than 2 wt. % via adsorption and neutralization of odor-active volatile organic compounds (VOCs) while retaining the mechanical properties of the thermoplastic composition. Thus, the polymer composition of the present invention can be used as a raw material, which can be injection molded or extruded into plastic components and used in many different applications including automotive components with the benefit of meeting customer specification of low odor emissions.

In one aspect of the invention, the thermoplastic composition can include a thermoplastic polymer and an amine-functionalized silica dispersed in the thermoplastic composition. The amine-functionalized silica can have a specific surface area of less than 450 m²/g and a nitrogen content of at least 1.2 wt. % (e.g., 1.25 wt. %, 1.275 wt. %, 1.30 wt. %, 1.325 wt. %, 1.35 wt. %, 1.375 wt. %, 1.40 wt. %, 1.5 wt. %, 1.6 wt. %, 2 wt. %, 3 wt. %, 4 wt. %, 5 wt. %, etc. or any value or range therein) based on the total weight of the amine-functionalized silica. The thermoplastic composition has decreased odor-active volatile organic compounds (VOCs) emissions when compared with the same thermoplastic composition that does not include the amine-functionalized silica. The odor-active VOCs can include a ketone, an aldehyde, an organic acid, an aliphatic hydrocarbon, an aromatic compounds, a sulfur-containing compound, a nitrogen-containing compound, a chlorine-containing compound, an ester compound, a terpene compound, or a combination thereof. In some embodiments, the thermoplastic composition can include an imine compound. The imine compound can be a reaction product of the amine-functionalized silica and the odor-active VOC comprised in the same thermoplastic composition that does not include the amine-functionalized silica. Such a reaction neutralizes the odor-active VOC. The resulting imine compound can include amino-silane groups. The amine-functionalized silica can also adsorb a portion of the odor-active VOCs, thus making the amine-functionalized silica a dual-active additive. The amount of odor-active VOCs can be reduced by at least 10% (e.g., at least 50%, at least 90%) as compared with the same thermoplastic composition that does not include the amine-functionalized silica. The amine-functionalized silica can have a pore volume of 0.1 to 1.8 cc/g, preferably 0.6 to 1.5 cc/g, and more preferably 0.8 to 1.2 cc/g, and a pore size of 3 to 35 nm, preferably 5 to 25 nm, and more preferably 10 to 15 nm. The thermoplastic composition can include a total of 0.01 wt. % to 65 wt. %, preferably 0.1 wt. % to 10 wt. %, more preferably 1 wt. % to 2 wt. % of the amine-functionalized silica. The mechanical properties of the thermoplastic composition are similar to the mechanical properties of the same thermoplastic polymer without the amine-functionalized silica.

The thermoplastic polymer, can include polypropylene (PP), polyethylene (PE), polyester, polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butylidene styrene (ABS), poly(methyl methacrylate) (PMMA), blend of polycarbonate and polybutylene terephthalate (PBT), blend of polycarbonate-acrylonitrile butadiene styrene (ABS), elastomeric block co-polymers, blend of polycarbonate-polyethylene terephthalate (PET), polyamide, polystyrene (PS), engineered thermoplastic polymers, or blends or copolymers thereof. The thermoplastic composition contains at least 35 to 99.99 wt. % of the thermoplastic polymer, and 0 to 55 wt. % additives.

In a preferred embodiment, the thermoplastic composition, based on the total weight of the thermoplastic composition, can include 0.01 wt. % to 65 wt. %, preferably 0.1 wt. % to 10 wt. %, more preferably 0.1 wt. % to 5 wt. %, most preferably 1 wt. % to 2 wt. % of the amine-functionalized silica, 35 wt. % to 99.99 wt. % of the thermoplastic polymer, and 0 wt. % to 55 wt. % additives. In some embodiments, the thermoplastic composition does not include latex, an odor masker, an oxygen layer, an ethylene-vinyl alcohol copolymer or a combination thereof.

The thermoplastic composition can be a pellet, a powder or a molded part. Non-limiting examples of the thermoplastic composition include an extrusion molded article, an injection molded article, a compression molded article, a rotational molded article, a blow molded article, an injection blow molded article, a 3-D printed article, a thermoformed article, or solvent cast film. Thermoplastic compositions of the present invention can be included in articles of manufacture. Non-limiting examples of an article of manufacture can include an exterior and/or interior vehicle part, an exterior and/or interior train part, an exterior and/or interior airplane part, an exterior and/or interior building part, an electrical device part, an electronic device part, an industrial device part, medical packing film and/or component, a medical tray, a blister pack, a medical component container, a food packing film, or a food container.

In one aspect of the invention, a thermoplastic composition includes a thermoplastic polymer, and an imine-functionalized silica having decreased volatile organic compound (VOC) emissions when compared with the same thermoplastic composition that does not include the imine-functionalized silica. The odor-active VOCs can be decreased at least 10%, preferably 50%, more preferably 90% as compared to the same thermoplastic composition without the imine-functionalized silica as determined.

Methods of preparing the thermoplastic composition of the present invention are described. A method can include compounding an amine-functionalized silica with a thermoplastic polymer that includes odor-active and volatile organic compounds (VOC) at 150° C. to 400° C. to produce the thermoplastic composition of the present invention. The amine-functionalized silica is produced by reacting an amine-functionalized silane with silica dispersed in solvent (e.g., anhydrous ethanol) in the presence of base. The amine-functionalized silane can have the following formula: H₂N—X—SiR¹ₙ(OR₂)₃₋ₙSi where n is 0, 1, or 2, X is a linear or branched divalent hydrocarbon group having 1 to 5 carbon atoms, R¹ and R² are alkyl groups each having 1 to 3 carbon atoms, preferably n is 0, X is linear divalent hydrocarbon group having 3 carbon atoms, and R¹ and R² are alkyl groups each alkyl groups having 2 carbon atoms. In a preferred embodiment, the amine-functionalized silane is (3-aminopropyl)triethoxysilane. In one embodiment, the compounding is performed at 220° C. to 300° C.

In the context of the present invention 20 embodiments are described. Embodiment 1 is a thermoplastic composition comprising a thermoplastic polymer and an amine-functionalized silica dispersed in the thermoplastic composition, wherein the amine-functionalized silica has a specific surface area of less than 450 m²/g wherein the thermoplastic composition has decreased odor-active volatile organic compounds (VOCs) emissions when compared with the same thermoplastic composition that does not include the amine-functionalized silica. Embodiment 2 is the thermoplastic composition of embodiment 1, further comprising an imine compound, wherein the imine compound is a reaction product of the amine-functionalized silica and the odor-active VOC comprised in the same thermoplastic composition that does not include the amine-functionalized silica. Embodiment 3 is the thermoplastic composition of embodiment 2, wherein the imine compound comprises amino-silane groups. Embodiment 4 is the thermoplastic composition of any one of embodiments 1 to 3, wherein the amine-functionalized silica adsorbs a portion of the odor-active VOCs. Embodiment 5 is the thermoplastic composition of any one of embodiments 1 to 4, wherein at least 10%, preferably 50%, more preferably 90% of the odor-active VOCs are reduced as compared with the same thermoplastic composition that does not include the amine-functionalized silica. Embodiment 6 is the thermoplastic composition of any one of embodiments 1 to 5, wherein the amine-functionalized silica has, a pore volume of 0.1 to 1.8 cc/g, preferably 0.6 to 1.5 cc/g, and more preferably 0.8 to 1.2 cc/g, and a pore size of 3 to 35 nm, preferably 5 to 25 nm, and more preferably 10 to 15 nm. Embodiment 7 is the thermoplastic composition of any one of embodiments 1 to 6, wherein the odor-active VOCs comprise a ketone, an aldehyde, an organic acid, an aliphatic hydrocarbon, an aromatic compounds, a sulfur-containing compound, a nitrogen-containing compound, a chlorine-containing compound, an ester compound, a terpene compound, or a combination thereof. Embodiment 8 is the thermoplastic composition of any one of embodiments 1 to 7, wherein the thermoplastic polymer comprises polypropylene (PP), polyethylene (PE), polyester, polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butylidene styrene (ABS), poly(methyl methacrylate) (PMMA), blend of polycarbonate and polybutylene terephthalate (PBT), blend of polycarbonate-acrylonitrile butadiene styrene (ABS), elastomeric block co-polymers, blend of polycarbonate-polyethylene terephthalate (PET), polyamide, polystyrene (PS), engineered thermoplastic compositions, or blends or copolymers thereof. Embodiment 9 is the thermoplastic composition of any one of embodiments 1 to 8, wherein the thermoplastic composition contains a total of 0.01 wt. % to 65 wt. %, preferably 0.1 wt. % to 10 wt. %, more preferably 1 wt. % to 2 wt. % of the amine-functionalized silica based on the total weight of the thermoplastic composition. Embodiment 10 is the thermoplastic composition of embodiment 9, wherein the thermoplastic composition contains at least 35 to 99.99 wt. % of the thermoplastic polymer, and 0 to 55 wt. % additives based on the total weight of the thermoplastic composition. Embodiment 11 is the thermoplastic composition of any one of embodiments 1 to 10, wherein the mechanical properties of thermoplastic composition are similar to the mechanical properties of the same thermoplastic polymer without the amine-functionalized silica. Embodiment 12 is the thermoplastic composition of any one of embodiments 1 to 11, wherein the thermoplastic composition does not comprise an odor masker, an oxygen layer, an ethylene-vinyl alcohol copolymer, or a combination thereof. Embodiment 13 is the thermoplastic composition of any one of embodiments 1 to 12, wherein the thermoplastic composition is a pellet, a powder, or a molded part. Embodiment 14 is the thermoplastic composition of any one of embodiments 1 to 13, wherein the thermoplastic composition is an extrusion molded article, an injection molded article, a compression molded article, a rotational molded article, a blow molded article, an injection blow molded article, a 3-D printed article, a thermoformed article, or solvent cast film. Embodiment 15 is the thermoplastic composition of any one of embodiments 1 to 14, wherein the thermoplastic composition is comprised in an article of manufacture. Embodiment 16 is the thermoplastic composition of embodiment 15, wherein the article of manufacture is an exterior and/or interior vehicle part, an exterior and/or interior train part, an exterior and/or interior airplane part, an exterior and/or interior building part, an electrical device part, an electronic device part, an industrial device part, medical packing film and/or component, a medical tray, a blister pack, a medical component container, a food packing film, or a food container.

Embodiment 17 is a method of preparing the thermoplastic composition of any one of embodiments 1 to 12, the method comprising compounding an amine-functionalized silica with a thermoplastic polymer comprising odor-active and volatile organic compounds (VOC) at 150° C. to 400° C. to produce the thermoplastic composition of embodiments 1 to 12. Embodiment 18 is the method of embodiment 17, wherein the amine-functionalized silica is produced by reacting an amine-functionalized silane with silica dispersed in solvent, wherein the amine-functionalized silane is represented by the following formula: H₂N—X—SiR¹ₙ(OR²)₃₋ₙSi where n is 0, 1, or 2, X is a linear or branched divalent hydrocarbon group having 1 to 5 carbon atoms, R¹ and R² are alkyl groups each having 1 to 3 carbon atoms, preferably n is 0, X is linear divalent hydrocarbon group having 3 carbon atoms, and R¹ and R² are alkyl groups each alkyl groups having 2 carbon atoms. Embodiment 19 is the method of any one of embodiments 17 to 18, wherein the compounding temperature is from 220° C. to 300° C. Embodiment 20 is the method of any one of embodiments 17 to 19, wherein the amine-functionalized silane is (3-aminopropyl)triethoxysilane.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

An alkyl group is linear or branched, substituted or unsubstituted, saturated hydrocarbon. Non-limiting examples of alkyl group substituents include alkyl, halogen, hydroxyl, alkoxy, haloalkyl, haloalkoxy, carboxylic acid, ester, amine, amide, nitrile, acyl, thiol and thioether.

The term “odor-active volatile organic compound(s)” refers to an organic compound(s) having a functional group selected from aldehydes, thiols, esters, amines, ketones, carboxylates, alcohols, aromatics, or combination thereof.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The thermoplastic compositions of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the thermoplastic composition of the present invention is the composition includes odiferous thermoplastic polymers and a dual-action amine-functionalized silica.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a schematic of a mechanism to reduce VOCs in a thermoplastic composition.

FIG. 2 is a scanning electron microscope (SEM) image of SiO₂ before amine functionalization.

FIG. 3 is a SEM image of the SiO₂ after amine functionalization.

FIG. 4 is a gas chromatography (GC) chromatogram of comparative PPc (dashed line)) and PPc of the present invention (solid line).

FIG. 5 is a GC-FID chromatogram of nonanal emissions from polypropylene of the inventive polymer composition (IR), comparative polymer composition (CR1) was processed under identical processing conditions as IR sample but without any additional additives, and a second comparative polymer composition (CR2) processed under identical processing conditions as IR sample, but with the addition of 2 wt. % non-functionalized silica. Nonanal is indicated by the star at t=25.6 min.

While the invention is susceptible to various modifications and alternative forms, specific embodiments thereof are shown by way of example in the drawings. The drawings may not be to scale.

### DETAILED DESCRIPTION OF THE INVENTION

At least one solution to some of the problems associated with odiferous thermoplastic compositions used to make articles of manufacture has been discovered. The solution can include compounding a thermoplastic polymer comprising VOCs, specifically odor-active VOCs with a dual-active functionalized silica (e.g., an amine-functionalized silica particle) at a temperature sufficient to cause odor-active VOCs to adsorb onto the silica particles and/or react with amine-functionalized silica particles to produce an imine-functionalized silica. The resulting thermoplastic composition has a decreased odor-active VOC emission of at least 10% as compared to the original thermoplastic composition without the dual-active functionalized silica.

These and other non-limiting aspects of the present invention are discussed in further detail in the following sections.

### A. Thermoplastic Composition

The thermoplastic composition of the invention includes a thermoplastic polymer and dual active functionalized silica particles (e.g., amine-functionalized silica particles having a specific surface area of less than 450 m²/g, less than 449 m²/g, less than 445 m²/g, less than 440 m²/g, less than 430 m²/g, less than 420 m²/g, or less than 410 m²/g, and a total nitrogen content of at least 1.2 wt. %, at least 1.25 wt. %, at least 1.275 wt. %, at least 1.3 wt. %, at least 1.325 wt. %, at least 1.35 wt. %, at least 1.375 wt. %, at least 1.4 wt. %, at least 1.425 wt. %, at least 1.45 wt. %, at least 1.475 wt. %, at least 1.5 wt. %, at least 1.525 wt. %, at least 1.55 wt. %, at least 1.575 wt. %, at least 1.6 wt. % at least 1.5 wt. %, at least 1.75 wt. %, at least 2 wt. %, at least 2.25 wt. %, at least 2.5 wt. %, at least 2.75 wt. %, at least 3 wt. %, at least 3.25 wt. %, at least 3.5 wt. %, at least 3.75 wt. %, at least 4 wt. %, at least 4.25 wt. %, at least 4.5 wt. %, or at least 4.75 wt. %) based on the total weight of the amine-functionalized silica. The thermoplastic composition has a decreased odor-active VOC emission of at least 10% as compared to the thermoplastic composition without the dual active functionalized silica particles (e.g., amine-functionalized silica particles). The decrease in odor-active VOC emission can be at least 10%, at least 20%, at least 30%, at least 50%, at least 60%, at least 70%, at least 80%, at least 90%, or 10% to 99.9%, 50% to 99.9%, or 70% to 99.9%, or 85% to 99. %, or 90% to 99.9% or any value or range there between. The thermoplastic composition includes a total of 0.01 wt. % to 65 wt. %, 1.5 wt. % to 50 wt. %, 10 wt. % to 30 wt. % of the dual active silica (e.g., amine-functionalized silica) based on the total weight of the thermoplastic composition. Non-limiting examples of the amount of total dual active silica includes 0.01 wt. %, 1 wt. %, 1.5 wt. %, 2 wt. %, 2.5 wt. %, 3 wt. %, 3.5 wt. %, 4 wt. %, 4.5 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. % or any range or value there between based on the total weight of the composition. In a preferred embodiment, 1 wt. % to 2 wt. % of the dual active silica (e.g., amine-functionalized silica) is dispersed in the thermoplastic polymer. The thermoplastic composition can have a total nitrogen content of at least 0.012 wt. % to 3.25 wt. % or 0.012 wt. %, 0.05 wt. %. 0.1 wt. %, 0.5 wt. %, 1 wt. %, 1.5 wt. %, 2 wt. %, 2.5 wt. %, 3 wt. %, 3.25 wt. % or any value or range therein based on the total weight of the thermoplastic composition. The thermoplastic composition of the present invention can include the at least 35 to 99.99 wt. % of the thermoplastic polymer based on the total weight of the thermoplastic composition. Non-limiting amounts of thermoplastic polymer, based on the total weight of the thermoplastic composition includes 35 wt. %, 40 wt. %, 45 wt. %, 50 wt. %, 55 wt. %, 60 wt. %, 65 wt. %, 70 wt. %, 75 wt. %, 80 wt. %, 90 wt. %, 95 wt. %, 95.5 wt. %, 96 wt. %, 96.5 wt. %, 97 wt. %, 97.5 wt. %, 98 wt. %, 98.5 wt. %, 99 wt. % or any value or range there between. The thermoplastic composition can include 0 to 55 wt. % additives based on the total weight of the thermoplastic composition. In one aspect, the thermoplastic composition, based on the total weight of the thermoplastic composition, includes 65 to 99 wt. % of the thermoplastic polymer, 0.01 wt. % to 35 wt. % of the dual active silica (e.g., amine-functionalized silica), and 0 to 55 wt. % additives based on the total weight of the composition. In one aspect, the thermoplastic composition includes 98 to 99 wt. % of the thermoplastic polymer, 1 wt. % to 2 wt. % of the amine-functionalized silica, and 0 to 1 wt. % additives based on the total weight of the thermoplastic composition. In another aspect, the thermoplastic composition includes 50 to 99 wt. % of the thermoplastic polymer, 0.01 wt. % to 3 wt. % of the amine-functionalized silica, and 0 to 55 wt. % additives based on the total weight of the thermoplastic composition. The thermoplastic composition can also include an imine-functionalized silica formed in situ. The thermoplastic polymeric composition of the present invention does not include odor maskers. In one aspect of the invention, the thermoplastic composition of the present invention does not include an oxygen barrier layer and/or an ethylene-vinyl alcohol copolymer. In another aspect of the invention, the thermoplastic composition of the present invention does not include an oxygen barrier layer, an ethylene-vinyl alcohol copolymer, odor maskers, or combinations thereof.

In some aspects of the invention, the inventive polymer composition demonstrates a suitable odor score as determined by the technique prescribed under VDA 270 standards. In some embodiments of the invention, the odor score improvement of the polymer composition of the present invention is at least 5%, alternatively at least 10%, alternatively at least 15%, over the odor score of the polymer component without functionalized silica particles, wherein the odor score is measured in accordance with VDA 270.

The thermoplastic compositions of the present invention can have a variety of properties. Non-limiting examples of properties include tensile modulus, tensile strength, tensile elongation, a flexural modulus; a flexural strength, a notched Izod impact strength, impact strength and the like. The thermoplastic composition can have one, all, or a combination of the above properties.

Tensile modulus of the thermoplastic compositions of the present invention that include polypropylene compositions and the dual-active amine-functionalized silica can be at least 1400 MPa, or 1400 MPa, 1500 MPa, 1600 MPa, 1700 MPa, 1800 MPa, 1900 MPa, 2000 MPa, or any value there between, or any range there between (e.g., 1400 MPa to 2000 MPa, 1500 MPa to 1900 MPa, 1600 MPa to 1800 MPa, and the like). Tensile modulus can be measured in accordance with ASTM D638.

Tensile strength of the thermoplastic compositions of the present invention can be at least 12 MPa, or 12 MPa, 13 MPa, 14 MPa, 15 MPa, 16 MPa, 17 MPa, 18 MPa, 19 MPa, 20 MPa, and any value there between or any range there between (e.g., 12 MPa to 20 MPa, 13 MPa to 19 MPa, 14 MPa, to 18 MPa and the like). Tensile strength can be can be measured in accordance with ASTM D638.

Tensile elongation of the thermoplastic compositions of the present invention can be 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 3.9%, or any value or range there between or any range there between, preferably 1% to 4%. Tensile elongation can be can be measured in accordance with ASTM D638.

Flexural modulus of the thermoplastic compositions of the present invention can beat least 2000 MPa, or 2100 MPa, 2200 MPa, 2300 MPa, 2400 MPa, 2500 MPa, or any value there between, or any range there between (e.g., 2000 MPa to 2500 MPa). Flexural modulus can be measured in accordance with ASTM D790.

Flexural stress of the thermoplastic compositions of the present invention can be at least 30 MPa, or 30 MPa, 31 MPa, 32 MPa, 33 MPa, 34 MPa, 35 MPa, 36 MPa, or any value there between or any range there between (e.g., 30 MPa to 36 MPa, 31 MPa to 35 MPa, 32 to 34 MPa and the like). Flexural stress can be measured in accordance with ASTM D790.

Notched Izod impact strength of the thermoplastic compositions of the present invention can be, at least 150 J/m, or 150 J/m, 160 J/m, 170 J/m, 180 J/m, 190 J/m, 200 J/m, 210 J/m, 220 J/m, 230 J/m, 240 J/m, or any value there between or any range there between (e.g., 150 J/m to 240 J/m, 160 J/m to 230 J/m, or 170 J/m to 220 J/m and the like). Notched Izod impact strength can be measured in accordance with ASTM D256.

Impact strength of the thermoplastic composition @−30° C. can be at least 28 J/m or 28 J/m, 29 J/m, 30 J/m, 31 J/m, 32 J/m or any value or range there between.

In some aspects of the present invention, the thermoplastic compositions have a tensile modulus of at least 1400 MPa, preferably 1500 MPa to 2000 MPa, a tensile strength of at least 12 MPa, preferably 12 MPa to 20 MPa, a tensile elongation of at least 1%, preferably 1% to 4%, a flexural modulus of at least 2000 MPa, preferably 2000 MPa to 2500 MPa, a flexural stress of at least 30 MPa, preferably 32 MPa to 36 MPa, a notched Izod impact strength of at least 150 J/m, preferably 150 J/m to 240 J/m, and an impact strength @−30° C. of at least 28 J/m.

### 1. Thermoplastic Polymers

The thermoplastic composition can include thermoplastic polymers, engineered thermoplastic polymers or thermoset polymers, co-polymers thereof, and blends thereof that are discussed throughout the present application. In some aspects of the invention, the polymer component is a thermoplastic polymer. In some preferred embodiments of the invention, the polymer component is a thermoset polymer. In some embodiments of the invention, the polymer component is an elastomeric polymer. In other embodiments, the polymer is an engineered thermoplastic polymer. In some aspects of the invention, the polymer component is selected from polypropylene (PP), polyethylene (PE), polyester, polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butylidene styrene (ABS), poly(methyl methacrylate) (PMMA), blend of polycarbonate and polybutylene terephthalate (PBT), blend of polycarbonate-acrylonitrile butadiene styrene (ABS), elastomeric block co-polymers, blend of polycarbonate-polyethylene terephthalate (PET), polyamide, polystyrene (PS) or blends or copolymers thereof. In some preferred embodiments of the invention, the polymer component is polypropylene or copolymers or blends thereof. In some preferred embodiments of the invention, the polymer component is selected from a blend of polycarbonate and polybutylene terephthalate (PBT), a blend of polycarbonate-acrylonitrile butadiene styrene (ABS), a blend of polycarbonate-polyethylene terephthalate (PET). In some embodiments of the invention, the polypropylene is a heterophasic polypropylene.

Non-limiting examples of polyethylene polymer that may be used for the purpose of the invention are linear low density polyethylene, low density polyethylene, and high density polyethylene. Non-limiting examples of polyester that may be used for the purpose of the invention are polyethylene terephthalate (PET), polybutylene terephthalate (PBT), poly(1,4-cyclohexylidene cyclohexane-1,4-dicarboxylate) (PCCD), glycol modified polycyclohexyl terephthalate (PCTG), poly(cyclohexanedimethylene terephthalate) (PCT), and polyethylene naphthalate (PEN).

Engineered thermoplastic polymers include polyesters, aliphatic polyesters (e.g., polylactic acid), aromatic polyesters, polyamides, polyimides, acrylates, methacrylates, styrenics, polycarbonates (PC), polytetrafluoroethylene (PTFE/Teflon), acrylonitrile butadiene styrene (ABS), poly(phenylene oxide) (PPO), polysulphone (PSU), poly(etherketone) (PEK), poly(etheretherketone) (PEEK), polyphenylene sulfide (PPS), polyoxymethylene plastic (POM/Acetal), polyvinyl chloride, polyurethane or a mixture thereof.

The thermoplastic polymers described above include odor-active VOCs or generate odor-active VOCs upon compounding the polymers into thermoplastic compositions.

### 2. Functionalized Silica Particles

In some embodiments of the invention, the functionalized silica particles (functionalized silica) is functionalized by at least one functional group capable of reacting with one or more odor active compound and forming a condensate reaction product. In some embodiments of the invention, the functionalizing compound is selected from aminosilane compounds, mercaptosilane compounds, carboxylated silane compounds, epoxy silane compounds, amine compounds, thiol compounds, organic acid compounds or combination thereof. In some preferred embodiments of the invention, the functionalizing compound is an aminosilane compound selected from (3-aminopropyl)triethoxysilane. The thermoplastic composition can include a total of 0.01 wt. % to 65 wt. %, preferably 0.1 wt. % to 10 wt. %, more preferably 1 wt. % to 2 wt. % of the functionalized silica based on the total weight of the thermoplastic composition. In some aspects, the amount of functionalized silica can be less than 10 wt. %, less than 9 wt. %, less than 8 wt. %, less than 7 wt. %, less than 6 wt. %, less than 5 wt. %, less than 4 wt. %, less than 3 wt. %, less than 2 wt. %, or less than 1 wt. %, less than 0.1 wt. % or any value or range there between based on the total weight of the thermoplastic composition. In some instances, the amount of functionalized silica in the thermoplastic composition can be 0.01 wt. % to 7 wt. %, 1 wt. % to 5 wt. %, 1 wt. % to 3 wt. %, 1 wt. % to 2 wt. % or any range there between based on the total weight of the thermoplastic composition. As may be appreciated by a skilled person, depending on the original concentration of odor active compound, the final concentration of the odor-active compound can be reduced to a suitable concentration for the polymer composition to be used in various industrial application while meeting a desired consumer specification on odor emissions.

The functionalized silica have suitable surface area to enable the odor active VOCs to be adsorbed in the pores of the functionalized silica particle and thereby provide a dual active functionalized silica. In some embodiments of the invention, each of the functionalized silica particles can have a surface area of at least 100 m²/g, alternatively at least 300 m²/g, alternatively at least 400 m²/g, alternatively at least 450 m²/g, or alternatively at least 550 m²/g. In some embodiments of the invention, each of the functionalized silica particles have a specific surface area ranging from 110 m²/g to 1000 m²/g, alternatively ranging from 200 m²/g to 800 m²/g, alternatively from 400 m²/g to 600 m²/g, or alternatively from 300 m²/g to 449 m²/g. For the purposes of the present invention, the surface area may be determined by measuring nitrogen adsorption according to the Brunauer, Emmett and Teller (BET) method. A pore volume of the functionalized silica can be the same or slightly less than the starting silica pore volume. The pore size of the functionalized silica can be the same or larger than the pore size of the starting silica.

In one preferred aspect of the present invention, the functionalized silica is an amine-functionalized silica. The amine-functionalized silica can have a specific surface area (SSA) of less than 450 m²/g, less than 449 m²/g, less than 445 m²/g, less than 440 m²/g, less than 430 m²/g, less than 420 m²/g, less than 410 m²/g, or 100 to 425 m²/g, 250 to 400 m²/g, 300 to 350 m²/g, or any range there between. Non-limiting SSA values include 100 m²/g, 150 m²/g, 200 m²/g, 210 m²/g, 220 m²/g, 230 m²/g, 240 m²/g, 250 m²/g, 260 m²/g, 270 m²/g, 280 m²/g, 290 m²/g, 300 m²/g, 310 m²/g, 320 m²/g, 330 m²/g, 340 m²/g, 350 m²/g, 360 m²/g, 370 m²/g, 380 m²/g, 390 m²/g, 400 m²/g, 410 m²/g, 420 m²/g, 425 m²/g or any range or value there between. In a preferred aspect, the amine-functionalized silica has a SSA of 312 m²/g. A pore volume of the amine-functionalized silica can be the same or slightly less than the starting silica pore volume. Non-limited examples of pore volume include 0.1 to 1.8 cc/g, 0.6 to 1.5 cc/g, or 0.8 cc/g, 1.2 cc/g, 1.3 cc/g, 1.4 cc/g or any range or value there between. The pore size of the amine-functionalized silica can be the same or larger than the pore size of the indigenous silica. Non-limiting examples of pore size values include 11 to 15 nm, or 11 mm, 11.5 nm, 12 nm, 12.5 nm, 13 nm, 13.5 nm, 14 nm, 14.5 nm, or 15 nm, or any range or value there between. A particle size of the amine-functionalized silica can range from 4 to 10 micrometers, or 4 micrometers, 5 micrometers, 6 micrometers, 7 micrometers, 8 micrometers, 9 micrometers, 10 micrometers or any range or value therein. In one aspect, the particle size of the amine-functionalized silica can be 4 micrometers to 6.4 micrometers, preferably 6.3 micrometers.

The amine-functionalized silane can have the general formula of H₂N—X—SiR¹ₙ(OR²)₃₋ₙSi where n is 0, 1, or 2, X is a linear or branched divalent hydrocarbon group having 1 to 5 carbon atoms, R¹ and R² are alkyl groups each having 1 to 3 carbon atoms. Preferably n is 0, X is linear divalent hydrocarbon group having 3 carbon atoms, and R¹ and R² are alkyl groups each alkyl groups having 2 carbon atoms. Amine-functionalized silanes can be purchased from commercial chemical manufacturing companies. The amine-functionalized silica can have a total nitrogen content of 1.2 wt. % up to 5 wt. %. Non-limiting values for nitrogen content can include 1.2 wt. %, 1.22 wt. %, 1.25 wt. %, 1.275 wt. %, 1.3 wt. %, 1.325 wt. %, 1.35 wt. %, 1.375 wt. %, 1.4 wt. %, 1.425 wt. %, 1.45 wt. %, 1.475 wt. %, 1.50 wt. %, 1.525 wt. %, 1.55 wt. %, 1.575 wt. %, or 1.60 wt. % 1.5 wt. %, 1.75 wt. %, 2 wt. %, 2.25 wt. %, 2.5 wt. %, 2.75 wt. %, 3 wt. %, 3.25 wt. %, 3.5 wt. %, 3.75 wt. %, 4 wt. %, 4.25 wt. %, 4.5 wt. %, 4.75 wt. %, or 5 wt. % or any value or range there between based on the total weight of the amine-functionalized silica. In one aspect of the invention, the amine-functionalized silica can have a SSA of less than 450 m²/g, a pore volume of 1 to 1.5 cc/g, and a pore size of 3 to 35 nm, and an average particle size (D50) 4 to 6.4 micrometers.

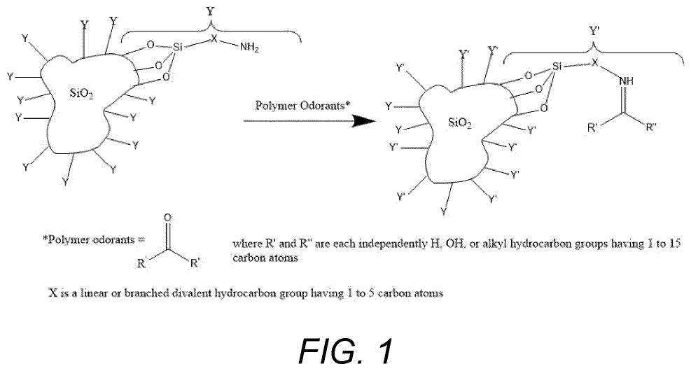

The thermoplastic composition can also include imine-functionalized silica. The imine-functionalized silica can be formed in situ by reaction of odor-active VOCs in the thermoplastic polymer with the amine-functionalized silica. The imine-functionalized silica can have the general formula of R′R″C═N—X—SiR¹ₙ(OR²)₃₋ₙSi where n is 0, 1, or 2, X is a linear or branched divalent hydrocarbon group having 1 to 5 carbon atoms, R¹ and R² are alkyl groups each having 1 to 3 carbon atoms. Preferably n is 0, X is linear divalent hydrocarbon group having 3 carbon atoms, and R¹ and R² are alkyl groups each alkyl groups having 2 carbon atoms. R′ and R″ are independently H, a hydroxyl group (OH), a substituted alkyl hydrocarbon, an alkyl hydrocarbon groups. R′ and R″ can have 1 to 15 carbon atoms. FIG. 1 shows a schematic representation of the reaction to form the imine-functionalize silica in situ, where n is 0.

The imine-functionalized silica can have a total nitrogen content of 1.2 wt. % up to 5 wt. %, 1.25 wt. % to 4 wt. %, 1.3 wt. % to 3.5 wt. %, or 2 wt. % to 3 wt. %. Non-limiting values for nitrogen content can include 1.2 wt. %, 1.22 wt. %, 1.25 wt. %, 1.275 wt. %, 1.3 wt. %, 1.325 wt. %, 1.35 wt. %, 1.375 wt. %, 1.4 wt. %, 1.425 wt. %, 1.45 wt. %, 1.475 wt. %, 1.50 wt. %, 1.525 wt. %, 1.55 wt. %, 1.575 wt. %, or 1.60 wt. % 1.5 wt. %, 1.75 wt. %, 2 wt. %, 2.25 wt. %, 2.5 wt. %, 2.75 wt. %, 3 wt. %, 3.25 wt. %, 3.5 wt. %, 3.75 wt. %, 4 wt. %, 4.25 wt. %, 4.5 wt. %, 4.75 wt. %, or 5 wt. % or any value or range there between based on the total weight of the imine-functionalized silica. The imine-functionalized silica can have a specific surface area of less than 450 m²/g, or 200 to 425 m²/g, 250 to 400 m²/g, 300 to 350 m²/g, or any range there between. Non-limiting SSA values include 200 m²/g, 210 m²/g, 220 m²/g, 230 m²/g, 240 m²/g, 250 m²/g, 260 m²/g, 270 m²/g, 280 m²/g, 290 m²/g, 300 m²/g, 310 m²/g, 320 m²/g, 330 m²/g, 340 m²/g, 350 m²/g, 360 m²/g, 370 m²/g, 380 m²/g, 390 m²/g, 400 m²/g, 410 m²/g, 420 m²/g, 425 m²/g or any range or value there between. In a preferred aspect, the imine-functionalized silica has a SSA of 312 m²/g. A pore volume of the imine-functionalized silica can be the same or slightly less than the starting silica pore volume. Non-limited examples of pore volume include 1 to 1.5 cc/g, or 1.1 cc/g, 1.2 cc/g, 1.3 cc/g, 1.4 cc/g or any range or value there between. The pore size of the imine-functionalized silica can be the same or larger than the pore size of the indigenous silica. Non-limiting examples of pore size values include 3 to 35 nm, 5 to 20 nm, 11 to 15 nm, or 3 nm, 4 nm, 5 nm, 6 nm, 7 nm, 8 nm, 9 nm, 10 nm, 11 mm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, or any range or value there between. In one aspect of the invention, the imine-functionalized silica can have a SSA of less than 450 m²/g, a pore volume of 1 to 1.5 cc/g, and a pore size of 3 to 35 nm. A particle size of the imine-functionalized silica can range from 4 to 10 micrometers, or 4 micrometers, 5 micrometers, 6 micrometers, 7 micrometers, 8 micrometers, 9 micrometers, 10 micrometers or any range or value therein. In one aspect, the particle size of the imine-functionalized silica can be 4 micrometers to 6.4 micrometers, preferably 6.3 micrometers.

Although the invention demonstrates by way of working examples the use of amine-functionalized silica to remove aldehydes, the amine functional group can also be used to target other high intensity odor-active oxygenate species including carboxylic acids, ketones, or alcohols found in polyolefin or engineering thermoplastics (ETP) and other polymeric material. Without wishing to be bound by any specific theory, it is believed that the functional group reacts with an odor active compound to form a condensate reaction product resulting in the removal of the odor characteristic from the polymer. Therefore, it may be appreciated that unlike odor masking agents, such as oil and fragrance, the solution provided by way of the present invention imparts significant removal of the odor active compounds brought about by chemically reacting the odor reactive compound and the functional group of functionalized silica.

### 3. Additives

The thermoplastic composition can include an amount of additives of 0 and 55 wt. %, preferably >0 and <55 wt. % or between 0.5 wt. % and <55 wt. % based on the total weight of the thermoplastic composition. Non-limiting examples of additives that can be used in the thermoplastic composition of the present invention can include an anti-fogging agent, an antioxidant, a heat stabilizer, a hindered amine light stabilizer, a flow modifier, an UV absorber, an impact modifier, a colorant, glass fiber, a reinforcing fiber, a fire retardant, a plasticizer, a compatibilizer, an anti-blocking agents, a nucleating agent, a clarifying agent, a mold release agent, an antistatic agent, an antimicrobial agent, blowing agent, a lubricant, a mineral filler, etc., or any combinations thereof.

Non-limiting examples of antioxidants include sterically hindered phenolic compounds, aromatic amines, a phosphite compound, carbon black and the like. Non-limiting examples of phenolic antioxidants include 2,6-di-tert-butyl-4-methylphenol (CAS No. 128-37-0), pentaerythritol-tetrakis(3-(3,5-di-tert-butyl-4-hydroxyphenyl) propionate (CAS No. 6683-19-8), octadecyl 3-(3′,5′-di-tert-butyl-4-hydroxyphenyl) propionate (CAS No. 2082-79-3), 1,3,5-trimethyl-2,4,6-tris-(3,5-di-tert-butyl-4-hydroxybenzyl)benzene (CAS No. 1709-70-2), 2,2′-thiodiethylenebis(3,5-di-tert-butyl-4-hydroxyphenyl) propionate (CAS No. 41484-35-9), calcium bis(ethyl 3,5-di-tert-butyl-4-hydroxybenzylphosphonate) (CAS No. 65140-91-2), 1,3,5-tris(3′,5′-di-tert-butyl-4′-hydroxybenzyl)-isocyanurate (CAS No. 27676-62-6), 1,3,5-tris(4-tert-butyl-3-hydroxy-2,6-dimethylbenzyl)-1,3,5-triazine-2,4,6-(1H,3H,5H)-trione (CAS No. 40601-76-1), 3,3-bis(3-tert-butyl-4-hydroxyphenyl)ethylene butyrate (CAS No. 32509-66-3), 4,4′-thiobis(2-tert-butyl-5-methylphenol) (CAS No. 96-69-5), 2,2′-methylene-bis-(6-(1-methyl-cyclohexyl)-para-cresol) (CAS No. 77-62-3), 3,3′-bis(3,5-di-tert-butyl-4-hydroxyphenyl)-N,N′-hexamethylenedipropionamide (CAS No. 23128-74-7), 2,5,7,8-tetramethyl-2-(4′,8′,12′-trimethyltridecyl)-chroman-6-ol (CAS No. 10191-41-0), 2,2-ethylidenebis(4,6-di-tert-butylphenol) (CAS No. 35958-30-6), 1,1,3-tris(2-methyl-4-hydroxy-5′-tert-butylphenyl)butane (CAS No. 1843-03-4), 3,9-bis(1,1-dimethyl-2-(beta-(3-tert-butyl-4-hydroxy-5-methylphenyl) propionyloxy)ethyl)-2,4,8,10-tetraoxaspiro[5.5]undecane (CAS No. 90498-90-1;), 1,6-hexanediyl-bis(3,5-bis(1,1-dimethylethyl)-4-hydroxybenzene) propanoate) (CAS No. 35074-77-2), 2,6-di-tert-butyl-4-nonylphenol (CAS No. 4306-88-1), 4,4′-butylidenebis(6-tert-butyl-3-methylphenol (CAS No. 85-60-9); 2,2′-methylene bis(6-tert-butyl-4-methylphenol) (CAS No. 119-47-1), triethyleneglycol-bis-(3-tert-butyl-4-hydroxy-5-methylphenyl) propionate (CAS No. 36443-68-2), a mixture of C₁₃ to C₁₅ linear and branched alkyl esters of 3-(3′,5′-di-tert-butyl-4′-hydroxyphenyl) propionic acid (CAS No. 171090-93-0), 2,2′-thiobis(6-tert-butyl-para-cresol) (CAS No. 90-66-4), diethyl-(3,5-di-tert-butyl-4-hydroxybenzyl)phosphate (CAS No. 976-56-7), 4,6-bis(octylthiomethyl)-ortho-cresol (CAS No. 110553-27-0), benzenepropanoic acid, octyl 3-(3,5-di-tert-butyl-4-hydroxyphenyl) propanoate (CAS No. 125643-61-0), 1,1,3-tris[2-methyl-4-[3-(3,5-di-tert-butyl-4-hydroxyphenyl) propionyloxy]-5-tert-butylphenyl]butane (CAS No. 180002-86-2), mixed styrenated phenols (CAS No. 61788-44-1), butylated, octylated phenols (CAS No. 68610-06-0), butylated reaction product of p-cresol and dicyclopentadiene (CAS No. 68610-51-5).

Non-limiting examples of phosphite antioxidant include one of tris(2,4-di-tert-butylphenyl)phosphite (CAS No. 31570-04-4), tris(2,4-di-tert-butylphenyl)phosphate (CAS No. 95906-11-9), bis(2,4-di-tert-butylphenyl) pentaerythritol diphosphite (CAS No. 26741-53-7); and tetrakis (2,4-di-butylphenyl)-4,4′-biphenylene diphosphonite (CAS No. 119345-01-6), and bis (2,4-dicumylphenyl) pentaerythritol diphosphite (CAS No. 154862-43-8).

Non-limiting examples of UV stabilizers include hindered amine light stabilizers, hydroxybenzophenones, hydroxyphenyl benzotriazoles, cyanoacrylates, oxanilides, hydroxyphenyl triazines, and combinations thereof. Non-limiting examples of hindered amine light stabilizers include dimethyl succinate polymer with 4-hydroxy-2,2,6,6-tetramethyl-1-piperidine ethanol (CAS No. 65447-77-0); poly[[6-((1,1,3,3-tetramethylbutyl)amino)-1,3,5-triazine2,4diyl][(2,2,6,6-tetramethyl-4-piperidyl)imino]hexamethylene[2,2,6,6-tetramethyl-4-piperidyl)imino]] (CAS No. 70624-18-9); and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane (CAS No. 106990-43-6).

Non-limiting examples of heat stabilizers include phenothiazine, p-methoxyphenol, cresol, benzhydrol, 2-methoxy-p-hydroquinone, 2,5-di-tert-butylquinone, diisopropylamine, and distearyl thiodipropionate (CAS No. 693-36-7). In a preferred embodiment, distearyl thiodipropionate which is sold under the trade name Irganox® PS 820 (BASF, Germany) is used.

Non-limiting examples of antioxidants include a mixture of at least two of 1,3,5-trimethyl-2,4,6-tris-(3,5-di-tert-butyl-4-hydroxybenzyl)benzene sold under the trade name of Irganox® 1330 (BASF, Germany), tris[2,4-bis(2-methyl-2-propanyl)phenyl]phosphite sold under the trade name of Irgafos® 168 (BASF, Germany), pentaerythritol-tetrakis (3-(3,5-di-tert-butyl-4-hydroxyphenyl) propionate sold under the trade name Irganox® 1010 (BASF, Germany), 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane sold under the trade name of Chimassorb 119 (BASF, Germany) is used.

Other additives can include stabilizers, UV absorbers, impact modifiers, and cross-linking agents. A non-limiting example of a stabilizer can include Irganox® B225, commercially available from BASF. In a still further aspect, neat polypropylene can be introduced as an optional additive. Non-limiting examples of UV absorbers include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, or combinations thereof. Non-limiting examples of impact modifiers include elastomers/soft blocks dissolved in matrix-forming monomer(s), such as, for example, bulk HIPS, bulk ABS, reactor modified PP, Lomod, Lexan EXL, and/or the like, thermoplastic elastomers dispersed in matrix material by compounding, such as, for example, di-, tri-, and multiblock copolymers, (functionalized) olefin (co) polymers, and/or the like, pre-defined core-shell (substrate-graft) particles distributed in matrix material by compounding, such as, for example, MBS, ABS-HRG, AA, ASA-XTW, SWIM, and/or the like, or combinations thereof. Non-limiting examples of cross-linking agents include divinylbenzene, benzoyl peroxide, alkylenediol di(meth)acrylates, such as, for example, glycol bisacrylate and/or the like, alkylenetriol tri(meth)acrylates, polyester di(meth)acrylates, bisacrylamides, triallyl cyanurate, triallyl isocyanurate, allyl(meth)acrylate, diallyl maleate, diallyl fumarate, diallyl adipate, triallyl esters of citric acid, triallyl esters of phosphoric acid, or combinations thereof.

### B. Method of Preparing the Thermoplastic Composition.

The thermoplastic composition of the present invention can be prepared using known polymer compounding techniques (e.g., single screw compounding, double screw compounding, kneading, masterbatch, and the like). For example, the thermoplastic polymer containing odor-active VOCs materials (See, Section A1), a desired amount of functionalized silica (see Section A2), and optionally additives (See, Section A3) can be added to a compounding machine (e.g., an extruder) at 150° C. to 400° C., or 200° C. to 350° C., or 220° C. to 300° C., or 225° C. to 235° C. and mixed for an appropriate time, e.g., 1 to 60 minutes, or until thoroughly dispersed. In one embodiment, the thermoplastic polymer can be polypropylene and the functionalized silica can be amine-functionalized silica and the processing conditions can be at least 225° C. to 300° C., preferably 225 to 235° C., more preferably 230° C. Prior to mixing and during mixing the odiferous VOC compounds are slowly released from the polymer. Upon mixing the amine portion of the amine-functionalized silica reacts with the VOC compounds and forms an imine-functionalized silica in situ (See, for example, FIG. 1).

An alternative approach to prepare the polymer composition of the present invention involves a masterbatch process. For example, a polymer binding component can be dissolved in a solvent to form a polymer solution. A functionalized silica dispersion can be added to the polymer solution at a temperature ranging from 10° C. to 500° C., or from 20° C. to 350° C., to forming a masterbatch precursor. The masterbatch precursor can be subjected to precipitation conditions to obtain a masterbatch that includes functionalized silica particles. The masterbatch can be compounded a polymer component (e.g., a thermoplastic polymer) to obtain the polymer composition of the present invention. Without wishing to be bound by any specific theory, it is believed that the polymer binder component ensures suitable compatibilization between the polymer component and the masterbatch to ensure suitable dispersion of the functionalized silica particles. In some embodiments of the invention, the solvent used for preparing the polymer solution may be any suitable non-polar industrial solvent, such as xylene or toluene, where the polymer may be dissolved under constant stirring and optionally under heat.

The functionalized silica can be prepared by grafting/bonding a functionalized compound (e.g., amine-functionalized silane) to the surface of silica. In one aspect, an advantage of the present invention is that a high nitrogen loading on a silica gel particle can be achieved while maintaining a desired surface area. For amine-functionalized silica particles, the silica can be dispersed in anhydrous ethanol or toluene to create a 5 to 50 wt. % dispersion. The solution can optionally be heated in an oil bath at up to 70° C. for up to 24 hours. Alternatively, silica can be added to a solution that includes solvent (e.g., ethanol, toluene, etc.) and amine-functionalized silane with agitation and optional heating up to 70° C. for desired amount of time. A desired amount of aqueous base can be added to the dispersion. Non-limiting examples of a base can include hydroxides, preferably ammonium hydroxide. To the dispersion, a desired amount of amine-functionalized silane (e.g., (3-aminopropyl)triethoxysilane (APTES)) can be added incrementally to the stirring silica dispersion and agitated at ambient temperature or optionally up to 70° C. for a desired amount of time, for example 0.5 to 2 hours. The weight ratio of silica to amine-functionalized silane can be 1:0.1 to 1:1. For example, 1:0.1, 1:0.2, 1:0.3, 1:0.4, 1:0.5, 1:0.6, 1:0.7, 1:0.8, 1:0.9, 1:1 or any range or value there between. The mixture can be filtered using know filtration techniques (e.g., gravitation, vacuum, centrifugation and the like), washed with ethanol, and dried (e.g., 65° C. to 110° C. for 0.5 to 16 hours). The final material can be lightly ground with a mortar and pestle, sieved and stored in a sealed container at ambient temperature.

In an alternative method, silica can be suspended in deionized water to form a 5 to 50 wt. % dispersion. The suspension can be agitated at room temperature. The amine-functionalized silane can be added incrementally to the suspension. The weight ratio of silica to amine-functionalized silane can be 1:0.1 to 1:1. For example, 1:0.1, 1:0.2, 1:0.3, 1:0.4, 1:0.5, 1:0.6, 1:0.7, 1:0.8, 1:0.9, 1:1 or any range or value there between. The mixture can be stirred at room temperature (e.g., 1 to 5 hours). Then the mixture can be filtered filtration techniques (e.g., gravitation, vacuum, centrifugation and the like), washed with deionized water, and dried (e.g., 90° C. for about 16 hours). The final material can be lightly ground with a mortar and pestle and stored in a sealed container at ambient temperature.

### C. Articles of Manufacture

In some aspects, the thermoplastic composition is in a pellet or powder form. The thermoplastic composition can be a molded composition (e.g., an extrusion molded, injection molded, compression molded, rotational molded, blow molded, injection blow molded). In other instances, the thermoplastic composition of the present invention is formed into films or sheets (e.g., solvent cast films), 3-D printed or thermoformed.

The thermoplastic composition of the present invention can be used to produce articles of manufacture. In some instances, these articles of manufacture have a minimal or no odor. Non-limiting examples article of manufacture is an exterior and/or interior vehicle part, an exterior and/or interior train part, an exterior and/or interior airplane part, an electrical device part, an electronic device part, an industrial device part, medical packing film and/or component, a medical tray, a blister pack, a medical component container, a food packing film, a food container.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### (Preparation of Amine-Functionalized Silica)

Silica (5 g) having a surface area of 662 m²/g and a pore volume of 1.6 cm³/g was taken in anhydrous ethanol (20 g, Acros Organics, 99.5%)) to create a 25 wt. % dispersion. To the dispersion, (3-aminopropyl)triethoxysilane (APTES, 1 g, Sigma-Aldrich®, 99%) was slowly added dropwise to the stirring silica dispersion and mixed at ambient temperature 0.5-2 hours. The mixture was filtered, washed with ethanol, and dried at 110° C. for 2 hours. The final material was lightly ground with a mortar and pestle, sieved and stored in a sealed container at ambient temperature.

### Example 2

### (Preparation of Amine-Functionalized Silica)

Silica (10 g) was suspended in deionized water (120 mL). Ammonium hydroxide (2.5 ml of 28-30% solution, Sigma Aldrich®) was added to the suspension. The suspension was magnetically stirred at room temperature. APTES (4.3 mL, 99% purity, Sigma Aldrich) was added dropwise to the suspension. The mixture was stirred at room temperature for 3 hours. Then the mixture was filtered, washed with deionized water, and dried at 90° C. for about 16 hours. The final material was lightly ground with a mortar and pestle and stored in a sealed container at ambient temperature.

### Example 3

### (Amine-Functionalized Silica Characterization)

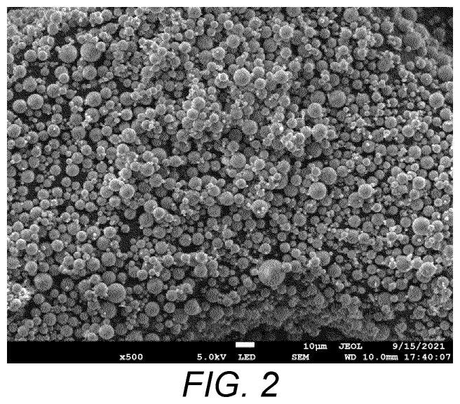

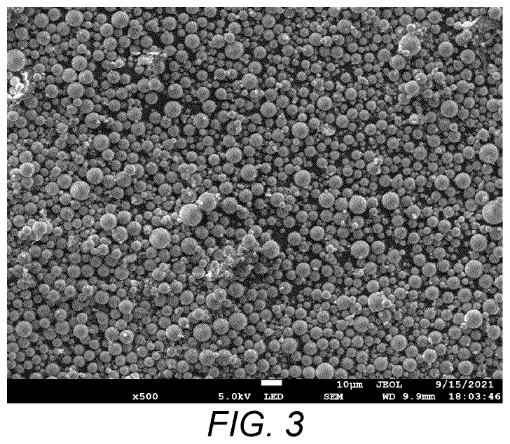

Material specifications before and after amine-functionalization according to Example 2 are shown in Table 1. A key indicator of sufficient amine-grafting is the measured nitrogen % and also retained porosity. The decrease in surface area and pore volume indicated bonding of APTES to the silica surface. In comparison, a failed functionalization would result in a very low porosity material (e.g., specific surface area (SSA) of less than 10 m²/g) even though nitrogen content may be high; indicating a shell was formed around a silica particle vs. grafted aminosilane. SEM images in FIGS. 2 and 3 show a near identical morphology of the silica particles after functionalization, giving further evidence of successful amino-grafting compared to coating or shell formation that would cause larger and/or irregular shared particles. Surface Area was determined by BET experimentation carried out by using Quantachrome Autosorb®-6iSA. Nitrogen content was determined by elemental analysis using a CHNS Chemical Analyzer.

TABLE 1

| | Before | After |
|---|---|---|
| | Functionalization | Functionalization |
| Appearance | White Powder | White Powder |
| Particle size (D₅₀, μm) | 6.6 | 6.3 |
| Specific surface area (m²/g) | 662 | 312 |
| Pore volume (cc/g) | 1.6 | 1.1 |
| Pore size (nm) | 10 | 14 |
| Nitrogen content (wt. %) | 0 | 2.0 |

### Example 4

### (Preparation of the Thermoplastic Composition of the Present Invention)

Ten gram batches of polypropylene-compound (PPc, mass flow rate (MFR) 20 dg/min @ 230° C.) with 2 wt. % of the amine-functionalized silica from Example 1 or 2 were added to a Xplore MC15 micro-compounder at 230° C. and mixed for 1 minute at 100 rpm. The compounded material was subsequently transferred to an Xplore IM12 and molded into flexural bars per ASTM D790. Four bars were shipped to IMAT for standardized odor testing per VDA 270. Additional molds were prepared for mechanical property testing including: flexural strength (ASTM D790), Izod impact strength (ASTM D256), and tensile strength (ASTM D638).

### Example 5

### (Preparation of the Comparative PPc)

The comparative samples were prepared in the same manner as the inventive sample (Example 4) except without the amine-functionalized silica. Ten gram batches of polypropylene-compound (PPc, mass flow rate (MFR) 20 dg/min @ 230° C.) was added to an Xplore IM12 and molded into flexural bars per ASTM D790. Four bars were shipped to IMAT for standardized odor testing per VDA 270. Additional molds were prepared for mechanical property testing including: flexural strength (ASTM D790), Izod impact strength (ASTM D256), and tensile strength (ASTM D638).

### Example 6

### (Characterization of the Thermoplastic Composition of the Present Invention)

Polymer emissions testing. TD-GCMS analysis was conducted to quantify detectable oxygenate species released from the resin. The instrument consists of an Agilent 7890B GC equipped with a Gerstel MTS sampler and Thermal Desorption Unit that was coupled to an Agilent 5977A Mass Spectrometer. The column is an Agilent Technologies HT-ULTRA2 50 m×0.320 mm with a film thickness of 0.52 μm (P/N 19091B-115). The samples were submitted in the form of extruded strands, which were further prepared and analyzed with the following procedure: Strands were cut to a weight of about 30 mg and introduced into a micro-vial insert which was placed inside a thermal desorption tube and heated to 200° C. for 5 minutes. Volatiles were collected into a cryotrap set at a temperature of −100° C. At the end of the desorption step, the temperature in the trap was increased to 280° C. allowing the volatiles to enter the GC column. The initial oven temperature was 40° C. The oven temperature was increased according to the following program: to 92° C. at 3° C./min, to 160° C. at 5° C. min and to 280° C. at 10° C./min and held at 280° C. for 10 minutes.

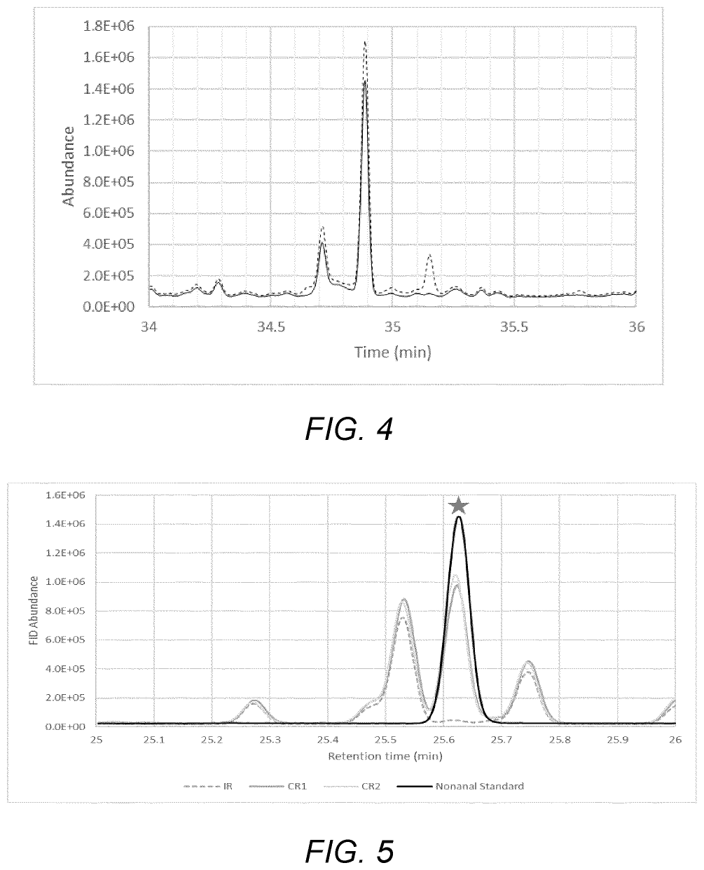

Emissions testing. Analysis was conducted on the comparative PPc and the PPc of the present invention using n=10 desorption steps (i.e., a total of 300 mg samples). The chromatogram in FIG. 4 shows dodecanal (t=35.15 min) peak area in the comparative PPc sample (dashed line chromatogram) was not observed in the PPc sample of the present invention (solid line chromatogram) Dodecanal is known to be an odorous component of fragrances occurring naturally in citrus oils and produced synthetically. Relative peak areas for dodecanal were 5,097,799 and 428,020 for comparative PPc and PPc of the present invention, respectively, a 91.6% decrease. Mass spec identified this peak as dodecanal (a known odorant) that has a very low odor threshold <1 ppm (ref: https://doi.org/10.1155/2020/3242854). In terms of its origin, we hypothesize that polymer processing conditions using elevated temperatures, oxygen-rich atmosphere and/or high shearing can cause oxidative degradation of the PP backbone and potentially other additives (e.g. stabilizers) to render new oxygenate species such as dodecanal.

Mechanical properties. Mechanical properties of the comparative PPc and PPc of the present invention was conducted and are listed in Table 2. Overall, the PPc of the invention had similar mechanical properties as the comparative PPc.

TABLE 2

| | | PPc of the |
|---|---|---|
| | Comparative | present |
| Test | PPc | invention |
| Izod impact notched @ 23° C. (J/m) | 238 ± 5.52 | 161 ± 12.7 |
| (ASTM D256) | | |
| Impact strength @ −30° (J/m) (ASTM | 32 ± 1.41 | 30.4 ± 1.78 |
| D256) | | |
| Flexural modulus (MPa) (ASTM D790) | 2200 ± 30.9 | 2160 ± 57.6 |
| Flex stress @ 5% strain (MPa) (ASTM | 35.9 ± 0.552 | 34.7 ± 0.254 |
| D790) | | |
| Flex stress @ Yield (MPa) (ASTM | 35.9 ± 0.554 | 34.7 ± 0.267 |
| D790) | | |
| Modulus of elasticity (MPa) (ASTM | 1580 ± 26.5 | 1526 ± 5.77 |
| D638) | | |
| Tensile strength at yield (MPa) (ASTM | 20.9 ± 0.20 | 19.9 ± 0.06 |
| D638) | | |
| Tensile strength at break (MPa) (ASTM | 12.5 ± 0.907 | 17.5 ± 1.25 |
| D638) | | |
| Elongation at yield (%) (ASTM D638) | 3.77 ± 0.01 | 3.13 ± 0.12 |
| Elongation at break (%) (ASTM D638) | 23.95 ± 4.25 | 4.31 ± 0.48 |
| Nominal strain at break (%) (ASTM | 16.13 ± 2.3 | 4.95 ± 0.47 |
| D638) | | |

### Example 7

### (Odor Testing of the Thermoplastic Composition of the Present Invention and Comparative Thermoplastic Compositions)

Odor testing was conducted at IMAT (Marietta, GA, USA) following the standard in accordance with VDA 270 (Variant B3). Odor grades were reported as a rounded average of the score provided by three individual panelists. The VDA 270 odor standard/gradation are listed in Table 3.

TABLE 3

| Grade | Evaluation Scale |
|---|---|
| Grade 1 | Not perceptible |
| Grade 2 | Perceptible, not disturbing |
| Grade 3 | Clearly perceptible, but not disturbing |
| Grade 4 | Disturbing |
| Grade 5 | Strongly disturbing |
| Grade 6 | Not acceptable |

Results. The results from the odor test are listed in Table 4 and were in accordance with VDA 270 standard conducted at IMAT Automotive Technology Services Inc. (Marietta, GA):

TABLE 4

| | Odor | Panelist | Panelist | Panelist | Std. | |
|---|---|---|---|---|---|---|
| | Grade | No. 1 | No. 2 | No. 3 | Deviation | Odor Profile |
| Inventive | 2.5 | 2.5 | 3.0 | 2.5 | 0.29 | Not clearly definable |
| Reference | | | | | | (Acceptable) |
| (IR) | | | | | | |
| Comparative | 3.0 | 3.0 | 3.0 | 3.5 | 0.29 | Not clearly definable |
| Reference 1 | | | | | | (Not desirable) |
| (CR1) | | | | | | |
| Comparative | 3.0 | 3.0 | 3.0 | 2.5 | 0.29 | Not clearly definable |
| Reference 2 | | | | | | (Not desirable) |
| (CR2) | | | | | | |

From the data obtained from the odor tests (Table 4), the inventive formulation (IR) comprising polypropylene (SABIC PP, MFR 47 dg/min at 230° C. and 2.16 kg) with 2 wt. % functionalized silica has a lower odor test value as compared to the “as is” polypropylene resin (CR1) and polypropylene with 2 wt. % non-functionalized silica (CR2). Thus, it was concluded that the odor reducing additives having functionalized silica particles have improved performance for odor reduction as compared to compositions, which do not have functionalized silica (CR2) or compositions, which contain only a neat polymer (CR1). In other words, polymer compositions having functionalized silica particles of the present invention, demonstrated reduced odor characteristics and are particularly suitable for many industrial applications, which demand such reduced odor characteristics.

### Example 8

### (Testing of Nonanal Odor Reduction in the Thermoplastic Composition of the Present Invention and Comparative Thermoplastic Compositions)

GC-MS-TDU Analysis sample preparation: Into a glass container, polypropylene (SABIC PP, MFR 47 dg/min at 230° C. and 2.16 kk) was taken with 100 ppm of nonanal (i.e. a high intensity odor-active volatile compound). The vessel was tightly sealed and placed on a platform shaker at 200 rpm for 16 hours. Approximately 10 grams of the nonanal-spiked polypropylene sample and 2.0 wt. % of the functionalized silica particles were added to an Xplore MC15 micro-compounder at 230° C. and mixed for 1 minute to form the inventive (IR) polymer composition. Similarly, CR1 was processed under identical processing conditions without any additional additives and CR2 was again processed similarly with the addition of 2 wt. % non-functionalized silica. The compounded materials (polymer composition) were collected as strands and transferred to thermal desorption tubes for analysis of nonanal concentration.

Measurement standard: An Agilent 7890B GC coupled to an Agilent 5977A Mass Spectrometer equipped with an Agilent HP-Ultra 2 column (50 m×0.320 mm and a film thickness of 0.52 mm (p/n 19091B-115)), a Gerstel Multipurpose Sampler (MPS), and Thermal Desorption Unit (TDU1) was used for the analysis. The samples were submitted in the form of extruded strands, which were further prepared and analyzed with the following procedure: Strands were cut to a weight of about 30 mg and introduced into a micro-vial insert which was placed inside a thermal desorption tube and heated to 200° C. for 5 minutes. Volatiles were collected into a cryotrap set at a temperature of −100° C. At the end of the desorption step, the temperature in the trap was increased to 280° C. allowing the volatiles to enter the GC column. The initial oven temperature was 40° C. The oven temperature was increased according to the following program: to 92° C. at 3° C./min, to 160° C. at 5° C. min and to 280° C. at 10° C./min and held at 280° C. for 10 minutes.

Results: The performance of the inventive composition and the reference samples are illustrated in FIG. 5, including a reference chromatogram for the nonanal standard (t=25.6 min). The performance is evaluated based on the relative abundance of nonanal concentration in the polymer composition before and after the addition of the odor reducing additives using gas chromatography (GC) analysis. The calculation is based on using the ratio of remaining nonanal released from the polymer compared to the starting nonanal concentration in the polymer without the functionalized silica particles. For the purposes of the present example, the initial nonanal concentration (prior to the addition of any odor reducing additives) in the polymer was taken as 100 ppm by weight as reference standard to measure the reduction in nonanal. Table 5 lists the nonanal emissions from polypropylene of the inventive polymer composition (IR) and the two comparative samples. As shown in Table 4, the functionalized silica achieved 97% reduction of nonanal in PP compared no reduction using the same concentration of non-functionalized silica.

TABLE 5

| | RT | | Sample Weight | Area Reduction |
|---|---|---|---|---|
| Sample | (min) | TIC Area | (mg) | (%) |
| CR1 | 25.623 | 26997690 | 33.46 | — |
| CR2 | 25.62 | 29171574 | 28.84 | 0.0 |
| IR | 25.615 | 810854 | 34.8 | 97.0 |

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A thermoplastic composition comprising a thermoplastic polymer and an amine-functionalized silica dispersed in the thermoplastic composition,
wherein the amine-functionalized silica has a nitrogen content of at least 1.2 wt. % and a surface area less than 450 m²/g,
wherein the amount of amine-functionalized silica is less than 7 wt. % based on the total weight of the thermoplastic composition, and
wherein the thermoplastic composition has decreased odor-active volatile organic compounds (VOCs) emissions when compared with the same thermoplastic composition that does not include the amine-functionalized silica.

2. The thermoplastic composition of claim 1, wherein the total nitrogen content of the amine-functionalized silica is 1.25 wt. % to 5 wt. % based on the total weight of the amine-functionalized silica.

3. The thermoplastic composition of claim 1, wherein the amine-functionalized silica has a specific surface area of less than 449 m²/g.

4. The thermoplastic composition of claim 1, wherein the amine-functionalized silica has a pore volume of 0.6 to 1.8 cc/g and a pore size of 5 to 25 nm.

5. The thermoplastic composition of claim 1, wherein the thermoplastic composition contains a total of 0.1 wt. % to 6 wt. % of the amine-functionalized silica, at least 35 to 99.99 wt. % of the thermoplastic polymer, and 0 to 55 wt. % additives based on the total weight of the thermoplastic composition.

6. The thermoplastic composition of claim 1, further comprising an imine compound, wherein the imine compound is a reaction product of the amine-functionalized silica and the odor-active VOC comprised in the same thermoplastic composition that does not include the amine-functionalized silica, wherein the imine compound comprises amino-silane groups.

7. The thermoplastic composition of claim 1, wherein the amine-functionalized silica adsorbs a portion of the odor-active VOCs.

8. The thermoplastic composition of claim 1, wherein at least 10% of the odor-active VOCs are reduced as compared with the same thermoplastic composition that does not include the amine-functionalized silica.

9. The thermoplastic composition of claim 1, wherein the odor-active VOCs comprise a ketone, an aldehyde, an organic acid, an aliphatic hydrocarbon, an aromatic compounds, a sulfur-containing compound, a nitrogen-containing compound, a chlorine-containing compound, an ester compound, a terpene compound, or a combination thereof.

10. The thermoplastic composition of claim 1, wherein the thermoplastic polymer comprises polypropylene (PP), polyethylene (PE), polyester, polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butylidene styrene (ABS), poly(methyl methacrylate) (PMMA), blend of polycarbonate and polybutylene terephthalate (PBT), blend of polycarbonate-acrylonitrile butadiene styrene (ABS), elastomeric block co-polymers, blend of polycarbonate-polyethylene terephthalate (PET), polyamide, polystyrene (PS), engineered thermoplastic compositions, or blends or copolymers thereof.

11. The thermoplastic composition of claim 1, wherein the mechanical properties of thermoplastic composition are similar to the mechanical properties of the same thermoplastic polymer without the amine-functionalized silica.

12. The thermoplastic composition of claim 1, wherein the thermoplastic composition does not comprise latex, an odor masker, an oxygen barrier layer, an ethylene-vinyl alcohol copolymer, or a combination thereof.

13. The thermoplastic composition of claim 1, wherein the thermoplastic composition is comprised in an article of manufacture and the article of manufacture is an exterior and/or interior vehicle part, an exterior and/or interior train part, an exterior and/or interior airplane part, an exterior and/or interior building part, an electrical device part, an electronic device part, an industrial device part, medical packing film and/or component, a medical tray, a blister pack, a medical component container, a food packing film, or a food container.

14. (canceled)

15. A method of preparing the thermoplastic composition of claim 1, the method comprising compounding an amine-functionalized silica with a thermoplastic polymer comprising odor-active and volatile organic compounds (VOC) at 150° C. to 400° C. to produce the thermoplastic composition of claim 1.

16. The method of claim 15, wherein the amine-functionalized silica is produced by reacting an amine-functionalized silane with silica dispersed in solvent in the presence of a base, wherein the amine-functionalized silane is represented by the following formula: H₂N—X—SiR¹ₙ(OR²)₃₋ₙSi where n is 0, 1, or 2, X is a linear or branched divalent hydrocarbon group having 1 to 5 carbon atoms, R¹ and R² are alkyl groups each having 1 to 3 carbon atoms, X is linear divalent hydrocarbon group having 3 carbon atoms, and R¹ and R² are alkyl groups each alkyl groups having 2 carbon atoms, and wherein the solvent comprises anhydrous ethanol, and the base.
